(19) United States
(12) Patent Application Publication
(10) Pub. No.: US 2012/0222316 A1
(43) Pub. Date: Sep. 6, 2012

(54) Apparatus for Cutting Hair

(75) Inventors: Gino Chiodo, Coraopolis, PA (US); Emilio Cornacchione, Pittsburgh, PA (US); George McConnell Davison, III, Pittsburgh, PA (US); Peter Arthur Meier, Pittsburgh, PA (US); Jason Reed Rogge, Belle Vernon, PA (US); Colin Derek Curry, Pittsburgh, PA (US)

(73) Assignee: GER, LLC, Pittsburgh, PA (US)

(21) Appl. No.: 13/410,755

(22) Filed: Mar. 2, 2012

Related U.S. Application Data
(60) Provisional application No. 61/448,492, filed on Mar. 2, 2011.

(51) Int. Cl. B26B 25/00; B26B 27/00

(52) U.S. Cl. 30/275.4; 30/290

(57) ABSTRACT

An apparatus for cutting hair and, in particular, bangs, includes a main body portion configured to fit against a forehead of a user, the main body portion including at least one comb positioned on a front side thereof, a cutting element slidably attached to the main body portion, an adjustable strap attached to the main body portion, the strap positioned around a head of the user to secure the main body portion against the user's forehead. Once the main body portion is secure, the hair of the user is pulled over the main body portion and through the at least one comb, and the cutting element is then slid across the main body portion cutting the hair pulled through the at least one comb. The apparatus thus permits the user to cut their hair, preferably their bangs, in any fashion, preferably straight.

### CROSS-REFERENCE TO RELATED APPLICATIONS

This patent application claims the benefit of co-pending U.S. Provisional Patent Application No. 61/448,492, filed on Mar. 2, 2011, which is hereby incorporated by reference in its entirety.

### FIELD OF THE INVENTION

The present disclosure is directed toward a haircutting apparatus and, more particularly, toward a haircutting apparatus that is designed to aid a person in the cutting of bangs and, even more particularly, toward a haircutting apparatus that is designed to aid a person in the cutting of straight bangs.

### BACKGROUND OF THE INVENTION

After getting their hair cut and styled at, for example, a salon, individuals often need touch-ups to certain portions of their hair. While not wanting to pay for a full haircut and style, individuals may want to have certain portions of their hair shortened, while letting other portions grow. For example, a person who wishes to let their hair grow long, may want the front portion of their hair, which is known as “bangs”, shortened or touched-up from time to time.

Trying to make a touch-up appointment at a salon if often difficult and expensive. Salons, especially the premiere salons, are often booked solid for weeks or months in advance. Even if a person is able to get an appointment, in addition to the monetary expense associated with touch-ups, there is often extensive time spent in traveling to, and waiting at, the salon. For example, a person who gets touch-ups at a salon twice a month, may spend upwards of 50 hours a year between travel time and waiting time at the salon, and spend upwards of $1,000 per year in salon “touch-up” costs.

As such, individuals have attempted to cut their hair themselves, or have others cut their hair for them. Problems, of course, arise when the individuals doing the cutting are inexperienced. Once a mistake is made, a person may have to live with a very undesirable haircut for months until it grows out. Alternately, they may go to a professional who will try to correct and/or compensate for the mistake (if it is possible to do so), which will end up costing a person more than if they went in for a touch-up.

Problems additionally arise when, for example, a parent tires to cut a child's hair, and the child won't sit still. Accidents can happen, resulting in severe physical injury.

An apparatus is therefore needed that will assist an individual in cutting their own hair, or the hair of others, inexpensively, safely and effectively.

The present inventive disclosure is directed toward overcoming one or more of the above-identified problems.

### SUMMARY OF THE INVENTION

In one embodiment, an apparatus for cutting hair is provided which includes a main body portion configured to fit against a forehead of a user, with the main body portion including at least one comb positioned on a front side thereof. A cutting element is slidably attached to the main body portion, such that the cutting element is slidable along the length of the main body portion. An adjustable strap is attached to the main body portion. The strap is positioned around a head of the user to secure the main body portion against the user's forehead. With the apparatus secured in place, the hair of the user is pulled over the main body portion and through the at least one comb located on the front side thereof, and then the cutting element is slid across the main body portion cutting the hair that has been pulled through the at least one comb.

The apparatus further includes a nose bridge extending from an underside of the main body portion for resting on a nose of a user.

In one form, the back surface of the main body portion is concave to fit snugly against a user's forehead.

In a further form, the main body portion includes top and bottom halves, and the at least one comb includes top and bottom combs provided on the top and bottom halves, respectively. A groove is provided in the front surface of the main body portion between the top and bottom combs.

In yet a further form, the cutting element includes a cutting housing and a cutting blade disposed therein, wherein the cutting housing is slidably attached to the main body portion. In a preferred form, the cutting blade includes a rotating cutting blade that rotates as the cutting housing is slid across the main body portion. In a further preferred form, the rotating cutting blade is made of stainless steel. The cutting housing may include top and bottom halves which are separable for cutting blade replacement.

In still a further form, the at least one comb includes top and bottom combs positioned on the front surface of the main body portion and spaced from one another, and wherein a groove is provided in the front surface of the main body portion between the top and bottom combs. The cutting element may include a cutting housing and a rotating cutting blade disposed therein, wherein with the cutting housing slidably attached to the main body portion, the rotating cutting blade extends into the groove between the top and bottom combs.

The cutting housing may include prongs which are received by cooperating grooves formed in the top and bottom surfaces of the main body portion and extending along the length thereof to slidably attach the cutting housing to the main body portion. A latch is provided on a side surface of the main body portion, with the latch positionable between open and closed positions for removal and reattachment of the cutting housing.

In another form, at least one biasing spring is provided in the cutting housing, wherein the at least one biasing spring biases the rotation cutting blade toward toe main body portion and into the groove with the cutting housing slidably attached to the main body portion. A cutting insert may be disposed in the main body portion, wherein when the cutting housing is attached to the main body portion, the rotating cutting blade is biased against the cutting insert. In a preferred form, the cutting insert is made of hard plastic. As the cutting housing is slid along the length of the main body portion, friction between the rotating cutting blade and the cutting insert causes the rotating cutting blade to rotate.

Guide markings may be provided on the top surface of the main body portion, the guide markings defining a cutting length of the cutting element.

In one form, the adjustable strap may include a cord and a clasp for tightening the cord about the head of a user.

It is an object of the present disclosure to provide an apparatus that will assist an individual in cutting their own hair, or the hair of others, inexpensively, safely and effectively.

Various other objects, aspects and advantages of the present inventive disclosure can be obtained from a study of the specification, the drawings, and the appended claims.

### BRIEF DESCRIPTION OF THE DRAWINGS

Advantages and useful features of the present disclosure also result from the description that follows of exemplary embodiments with reference to the drawings, to which the invention defined by the claims appended hereto is not limited. The details of one or more embodiments of the disclosure are set forth in the accompanying drawings and the description below. Other features, objects and advantages will be apparent from the description and the drawings, and from the claims. In the drawings:

FIG. 1 is a first perspective view of an apparatus for cutting hair according to one embodiment of the present disclosure;

FIG. 2 is an exploded view of FIG. 1;

FIG. 3 is a second perspective view of an apparatus for cutting hair according to one embodiment of the present disclosure;

FIG. 4 is a rear perspective view of an apparatus for cutting hair according to one embodiment of the present disclosure;

FIG. 5 is a top view of FIG. 1;

FIG. 6 is a bottom view of FIG. 1;

FIG. 7 is a right side view of FIG. 1;

FIG. 8 is a left side view of FIG. 1;

FIG. 9 is a front view of FIG. 1; and

FIG. 10 is a rear view of FIG. 1.

### DETAILED DESCRIPTION OF THE INVENTION

The haircutting apparatus of the present disclosure is designed to aid a person in the cutting of bangs and, in particular, straight bangs. It may be also referred to herein as the BEAUTIFUL BANGS™ device.

The inventive haircutting apparatus is designed to be used by both the professional and non-professional alike. It is preferably designed as a do-it-yourself tool to cut hair that grows from the area above the forehead and is either combed down or to the side is a way that allows the hair to hang in total, or in part, over the forehead. This portion of hair is commonly referred to as “bangs”. The inventive haircutting apparatus disclosed herein allows the user to cut or style this portion of the hair known as the “bangs” in various shapes and angles of the user's design. The inventive haircutting apparatus may be used by any person (women, children, men) with hair styled in the shape of bangs.

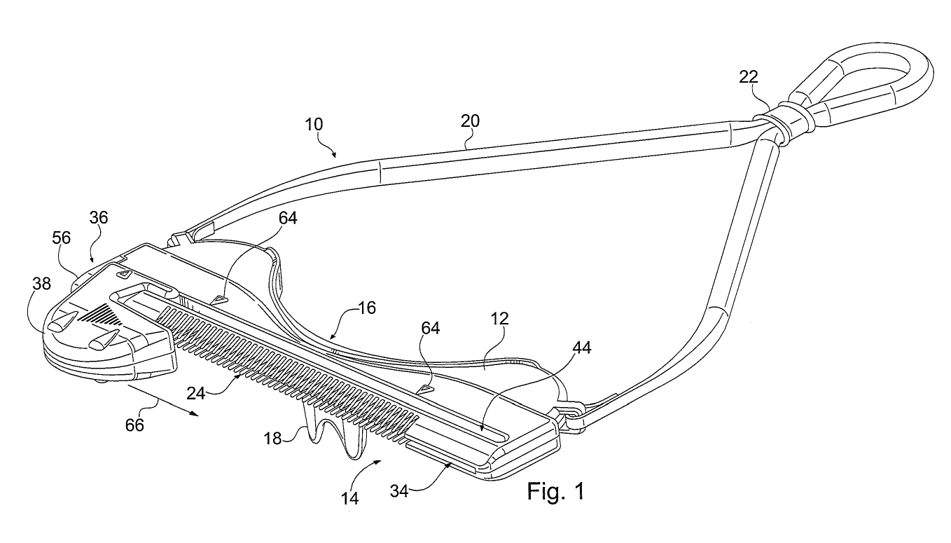

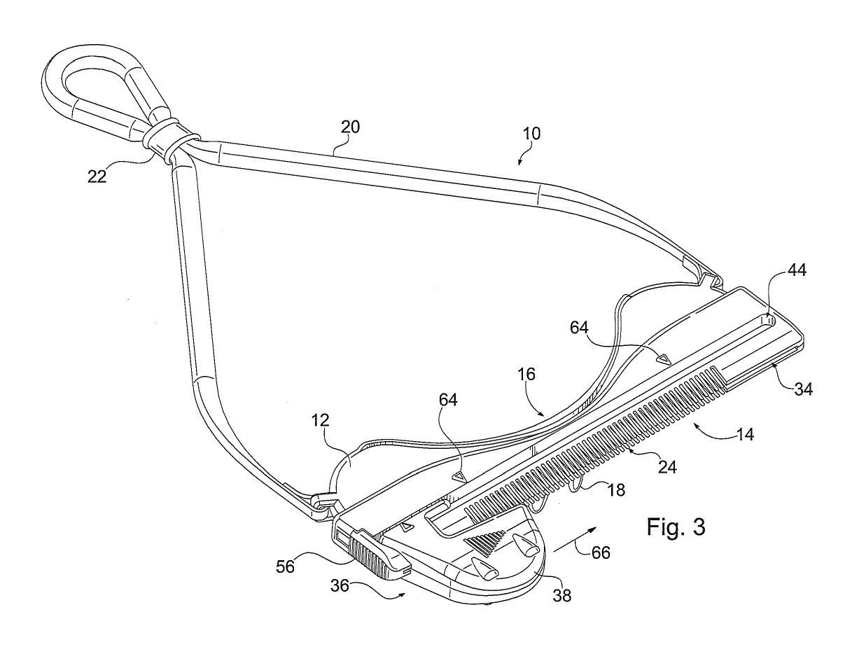

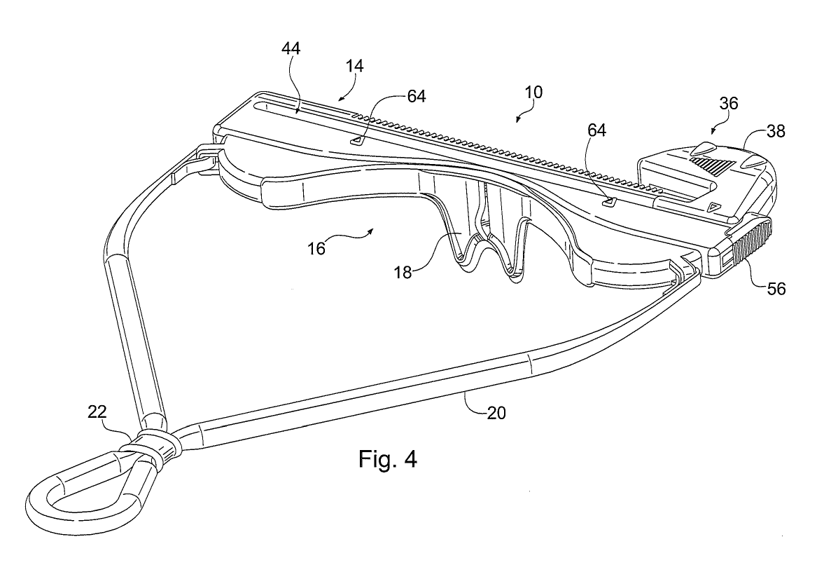

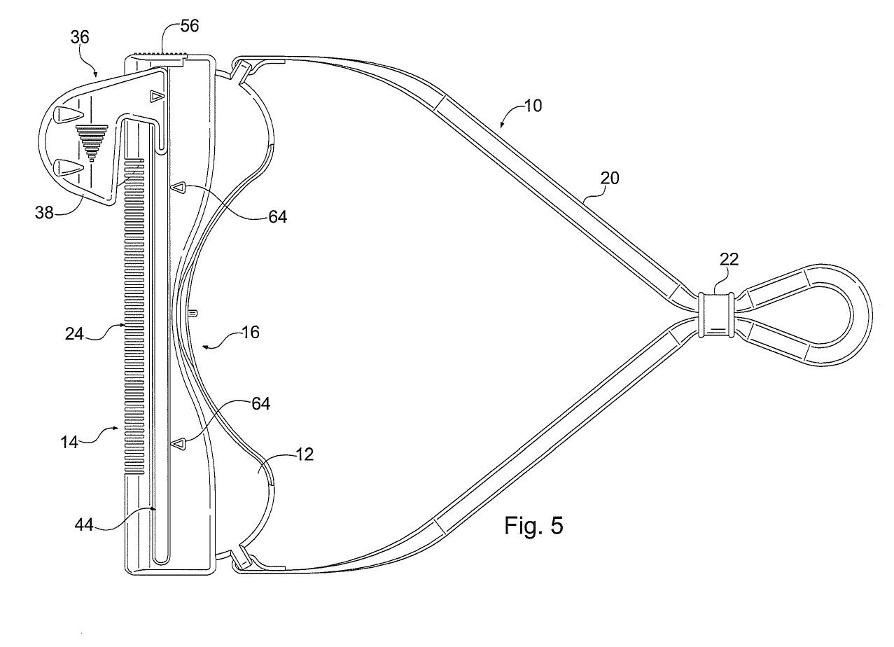

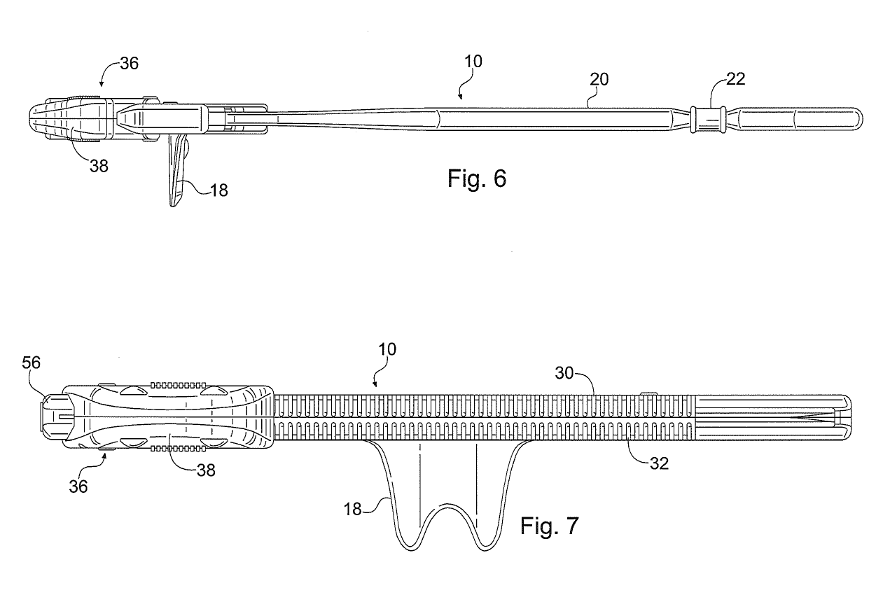

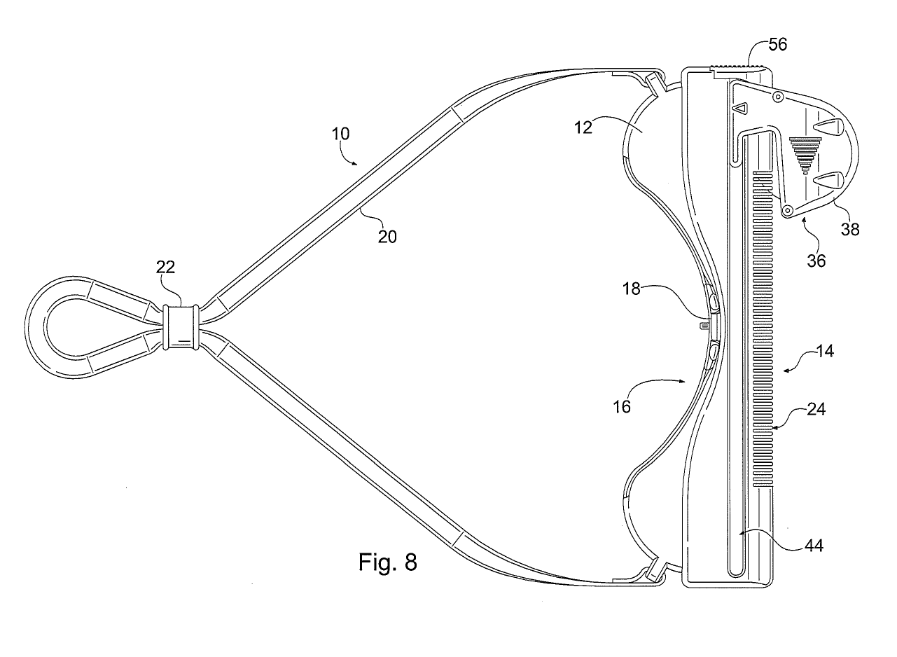

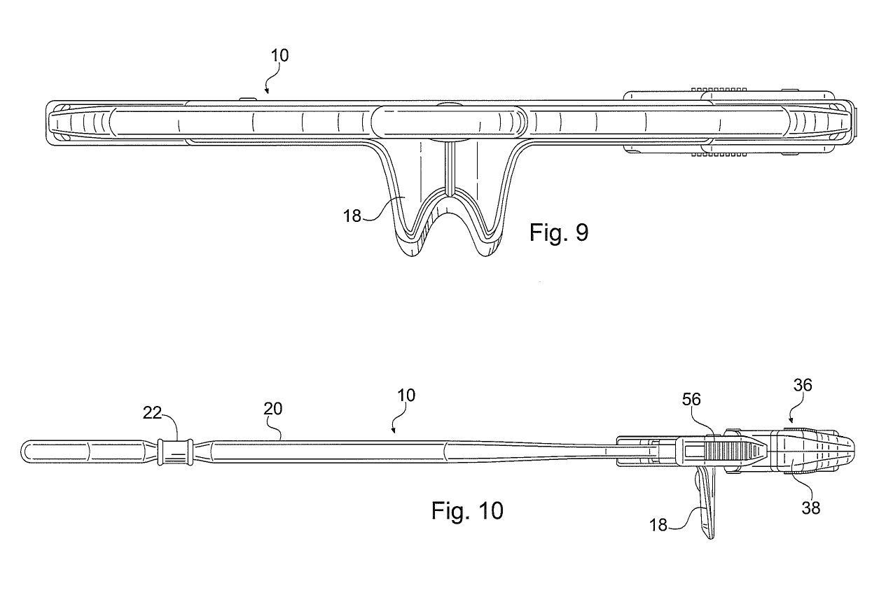

Referring to FIGS. 1-10, the inventive haircutting apparatus, shown generally at 10, includes a main body portion, or base, 12 that is designed to sit, or rest against, the forehead of a user. The main body portion 12 includes a generally straight front surface 14 and a curved back surface 16. The curvature of the back surface 16 is generally concave and designed to sit flush and fit snugly against a person's forehead when the apparatus 10 is in use. A pad or other cushioning strip may be provided on the back surface 16. A nose bridge 18 extends downward from the main body portion 12 and is designed to sit on a person's nose (similar to the nose bridges on eye glasses) to assist is positioning and supporting the apparatus 10 on the head of a person. A strap 20 (e.g., approximately 14-16″ in length) is secured to either side of the main body portion 12 and is designed to be positioned around the head of the user; preferably above the ears. The strap 20 may be made of cord, string, rope, and/or essentially any elastic or non-elastic material. In one embodiment, as shown in the Figures, a strap adjuster, or clamp, 22 is provided on the strap 20 and may be adjusted along the length of the strap 20 to secure the apparatus 10 to the forehead of a user. The strap adjuster 22 can be any known device to tighten the strap 20 and secure the apparatus to the forehead of a user. While one strap 20 is shown in the Figures, multiple straps may be used, as well as other methods of securing the main body portion to the forehead of a user, without departing from the spirit and scope of the present invention.

In one embodiment, the physical size of the inventive apparatus 10 can be approximately 10″ long×2.5″ wide×0.25″ thick, with the nose bridge 18 that extends downward approximately 1.5″ below the undersurface. The back surface 16 of the main body portion 12, which sits against a user's forehead, can be concave along a length of approximately 7″, with the concavity being approximately 1.5″ deep in the middle. The back surface 16 of the main body portion 12 is designed to fit the curvature of the forehead while the nose bridge 18, which protrudes from the bottom, rests on the bridge of the nose of a user. This physical size will accommodate most sized heads. However, other physical sizes are contemplated and may be implemented within the spirit and scope of the present invention.

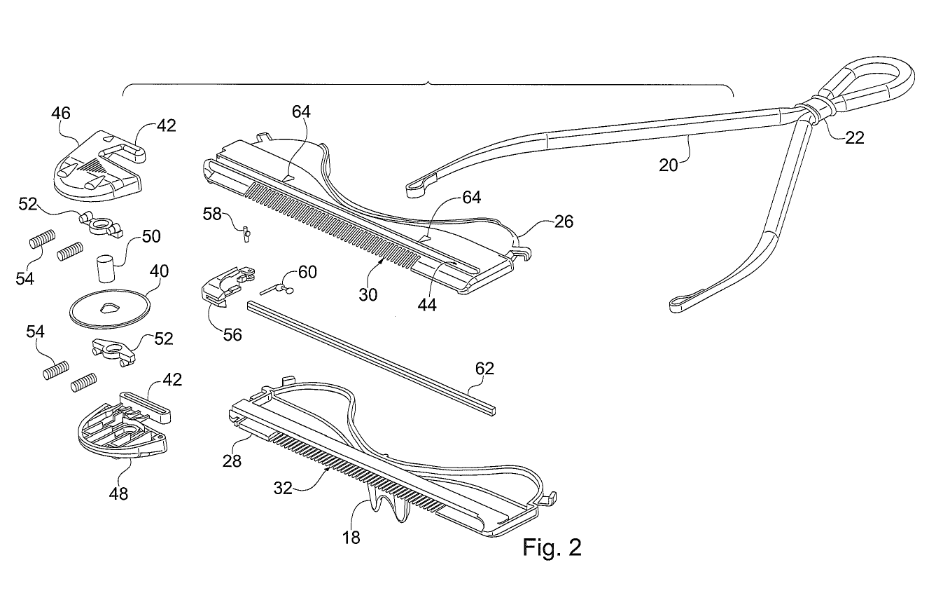

A comb 24 is provided along the front surface 14 of the main body portion 12. As shown more clearly in FIG. 2, the main body portion 12 includes a top half 26 and a bottom half 28. The two halves 26 and 28 are glued or otherwise fastened together to form the main body portion 12. The comb 24 includes a top comb 30 provided on the top half 26, and a bottom comb 32 provided on the bottom half 28. The top 30 and bottom 32 combs generally align when the halves 26 and 28 of the main body portion 12 are joined together, and are generally centered with respect to the main body portion 12. In the exemplary physical size given above, the combs 30 and 32 can each be approximately 7-8″ in length. A groove 34 is provided in the front surface 14 of the main body portion 12 between the top 30 and bottom 32 combs. In one exemplary form, the groove 34 is approximately 0.25″ wide and 0.35″ deep, and is designed to receive a blade for cutting hair, as will be described in more detail below.

Attached to the front surface 14 of the main body portion 12 is a cutting element 36. The cutting element 36 is slidably attached to the main body portion 12 such that it can move along the length thereof. The cutting element 36 includes a blade housing 38 (e.g., generally half circular in shape), which is open on the front edge thereof exposing a generally circular cutting blade 40 (see FIG. 2). Two prongs 42 extend from the blade housing 38 along the top and bottom thereof and include protrusions that fit into corresponding groves 44 provided on the top 26 and bottom 28 halves of the main body portion 12. Engagement of the prongs 42 with the grooves 44 allows the blade housing 38 to reciprocally slide back and forth along the length of the front surface 14 of the main body portion 12, while at the same time staying fixed to the main body portion 12.

As shown more clearly in FIG. 2, the blade housing 38 includes top 46 and bottom 48 halves. The two halves 46 and 48 are glued or otherwise fastened together to form the blade housing 38. In one form, the top 46 and bottom 48 halves are attached by screws (not shown). This allows the blade housing 38 to be opened and the blade 40 replaced. Inside the blade housing 38 is the cutting blade 40, which is attached to the blade housing 38 for spinning movement about an axis. In one form, the cutting blade 40 can be a generally circular stainless steel beveled cutting blade. The circular blade 40 includes a center hole for receiving a pin 50, around which the blade 40 freely spins. On either side of the blade 40 within the blade housing 38 are slider elements 52 which aid in keeping the blade 40 spinning transverse to its axis. The slider elements 52 also include apertures for receiving the pin 50. Springs 54, also within the blade housing 38, engage the slider elements 52 and bias the slider elements 52, and hence the blade 40, in a direction toward the main body portion 12, with the blade housing 38 attached to the main body portion 12.

The blade housing 38 is situated on the main body portion 12 so that the blade 40 extends into the groove 34 formed along the front surface 14 of the main body portion 12 between the combs 26 and 28. The blade housing 38 is removable from the main body portion 12 through a latch 56 provided on one side of the main body portion 12. The latch 56 pivots about a latch pin 58 and is biased by a torsion spring 60 in a conventional manner. Pivoting the latch 56 to an open position, allows the blade housing 38 to be removed from the main body portion 12. Opening the latch 56 also allows the blade housing 38 to be fitted back into the top and bottom grooves 34 to permit the blade housing 38 to slide along the length of the main body portion 12. In the embodiment shown, the latch is provided on the right side of the main body portion 12, however, it may be provided on the left side as well.

Provided within the main body portion 12 is a hard plastic insert 62 (see FIG. 2) which is disposed along the length of the main body portion 12 in the area in between the top 30 and bottom 32 combs. When the blade housing 38 is attached to the main body portion 12, the blade 40 is biased against the insert 62. As the blade housing 38 is slid along the length of the main body portion 12, the friction between the blade 40 and the insert 62 causes the blade to rotate. In one embodiment, the front face of the insert 62 may extend out a small amount from the plane of the front surface 14 of the main body portion 12 and into the comb 24 area.

When the inventive haircutting apparatus 10 is worn properly, the protruding nose bridge 18 is resting on the bridge of the nose of a user, with the concave back surface 16 fitted snuggly to the front of the forehead. The strap 20 is positioned around and behind the head and, preferably, positioned along the top of the ears. The adjustable strap 20 is then pulled tight, via the clamp 22, so that the main body portion 12 is secure against the head and in the proper position.

Once the inventive haircutting apparatus 10 is properly positioned and secure, the user pulls their hair (e.g., the hair that hangs in total, or in part, over the forehead) over the main body portion 12 and into the comb 24. Preferably, the hair to be cut should be positioned in between the guide markings 64 provided on the top of the main body portion 12. The guide markings 64 generally indicate the cutting area of the blade 40. Once the hair is pulled securely over and into the top 30 and bottom 32 combs on the front surface 14 of the main body portion 12, the user clasps the blade housing 38 and smoothly slides the blade housing 38 along the grooves 44, from right to left in the embodiment shown, in the direction of arrow 66 and cuts the hair. In one embodiment, the force of the blade 40 against the inset 62 assists in cutting the hair. In the embodiment shown, it is preferred if the user grasps the main body portion 12 with their right hand and the blade housing 38 with their left hand to slide the blade housing 38 along the main body portion 12. However, a user may implement any method for sliding the blade housing 38.

While the haircutting apparatus 10 has been shown and described herein as one that cuts from right to left, one skilled in the art will appreciate that a device that cuts from left to right can be easily implemented without departing from the spirit and scope of the present invention. Additionally, the blade 40 and blade housing 38 can be designed to cut in one direction only, or in both directions

It is contemplated herein that the haircutting apparatus 10 of the present disclosure be made of hard plastic or polymer material, except for the cutting blade 40 which is preferably made from stainless steel. However, other materials are contemplated and may be used without departing from the spirit and scope of the present invention.

It will be apparent to those skilled in the art that numerous modifications and variations of the described examples and embodiments are possible in light of the above teachings of the disclosure. The disclosed examples and embodiments are presented for purposes of illustration only. Therefore, it is the intent to cover all such modifications and alternate embodiments as may come within the true scope of this invention, which is to be given the full breadth thereof. Additionally, the disclosure of a range of values is a disclosure of every numerical value within that range.

I/We claim:

1. An apparatus for cutting hair comprising:
a main body portion configured to fit against a forehead of a user, the main body portion including at least one comb positioned on a front surface thereon;
a cutting element slidably attached to the main body portion;
an adjustable strap attached to the main body portion, the strap positioned around a head of the user to secure the main body portion against the user's forehead,
wherein the hair of the user is pulled over the main body portion and through the at least one comb, and
wherein the cutting element is slid across the main body portion cutting the hair pulled through the at least one comb.

2. The apparatus of claim 1, further comprising a nose bridge extending from an underside of the main body portion for resting on a nose of a user.

3. The apparatus of claim 1, wherein a back surface of the main body portion is concave to fit snugly against a user's forehead.

4. The apparatus of claim 1, wherein the main body portion comprises top and bottom halves, and wherein the at least one comb comprises top and bottom combs provided on the top and bottom halves, respectively, and wherein a groove is provided in the front surface of the main body portion between the top and bottom combs.

5. The apparatus of claim 1, wherein the cutting element comprises a cutting housing and a cutting blade disposed therein, wherein the cutting housing is slidably attached to the main body portion.

6. The apparatus of claim 5, wherein the cutting blade comprises a rotating cutting blade that rotates as the cutting housing is slid across the main body portion.

7. The apparatus of claim 6, wherein the rotating cutting blade comprises stainless steel.

8. The apparatus of claim 5, wherein the cutting housing comprises top and bottom halves which are separable for cutting blade replacement.

9. The apparatus of claim 1, wherein the at least one comb comprises top and bottom combs positioned on the front surface of the main body portion and spaced from one another, and wherein a groove is provided in the front surface of the main body portion between the top and bottom combs.

10. The apparatus of claim 9, wherein the cutting element comprises a cutting housing and a rotating cutting blade disposed therein, wherein with the cutting housing slidably attached to the main body portion, the rotating cutting blade extends into the groove between the top and bottom combs.

11. The apparatus of claim 10, wherein the cutting housing includes prongs which are received by cooperating grooves formed in the top and bottom surfaces of the main body portion and extending along the length thereof to slidably attach the cutting housing to the main body portion.

12. The apparatus of claim 11, further comprising a latch on a side surface of the main body portion, the latch positionable between open and closed positions for removal and reattachment of the cutting housing.

13. The apparatus of claim 10, further comprising at least one biasing spring provided in the cutting housing, wherein the at least one biasing spring biases the rotation cutting blade toward toe main body portion and into the groove with the cutting housing slidably attached to the main body portion.

14. The apparatus of claim 13, further comprising a cutting insert disposed in the main body portion, wherein when the cutting housing is attached to the main body portion, the rotating cutting blade is biased against the cutting insert.

15. The apparatus of claim 14, wherein the cutting insert is made of hard plastic.

16. The apparatus of claim 14, wherein as the cutting housing is slid along the length of the main body portion, friction between the rotating cutting blade and the cutting insert causes the rotating cutting blade to rotate.

17. The apparatus of claim 1, further comprising guide markings provided on a top surface of the main body portion, the guide markings defining a cutting length of the cutting element.

18. The apparatus of claim 1, wherein the adjustable strap comprises a cord and a clasp for tightening the cord about the head of a user.
